(19) United States
(12) Patent Application Publication
(10) Pub. No.: US 2005/0066581 A1
(43) Pub. Date: Mar. 31, 2005

(54) Weather-strip

(75) Inventors: Joel T. Rhode, St. Paul, MN (US); James L. Peterson, Woodbury, MN (US)

Correspondence Address: Z. Peter Sawicki;Westman, Champlin & Kelly, Suite 1600, 900 Second Avenue South, Minneapolis, MN, 55402-3319, US

(73) Assignee: Intek Plastics, Inc., Hastings, MN (US)

(21) Appl. No.: 10/948,350

(22) Filed: Sep. 23, 2004

Related U.S. Application Data
(60) Provisional application No. 60/506,508, filed on Sep. 26, 2003.

(51) Int. Cl. E05D 15/16

(52) U.S. Cl. 49/414

(57) ABSTRACT

A free-floating weather-strip is positioned between two surfaces, one surface having a slot. The slot has a back wall, an opening and retaining edges. The weather-strip includes a longitudinal main body having a weather-strip sealing portion and a pair of leg portions that extend into the slot and engage the retaining edges. The weather-strip is positioned within the slot and retained therein by the cooperation of the retaining edges with the leg portions. A pair of spring arms are attached to a backside of the main body and engage the back wall of the slot. The pair of spring arms provide a spring force that causes the weather-strip sealing portion into sealing engagement with the other of the two surfaces.

### CROSS REFERENCE TO RELATED APPLICATION

This application claims the benefit of U.S. Provisional Patent Application Ser. No. 60/506,508, filed Sep. 26, 20003.

### BACKGROUND OF THE INVENTION

The present invention generally relates to a jambliner for use in a window assembly. More particularly, the present invention relates to a weather-strip for use with the jambliner of a window assembly.

Jambliners are typically used in conjunction with a double-hung window having upper and lower window sashes. Jambliners are mounted to each side of a vertical jamb to receive and guide the slidable upper and lower window sashes. Typically, the jambliners are configured to mate with the sides of the sashes or hardware attached to the sashes to guide the sashes' movement.

The sashes of the double-hung windows are held in place at selected positions with various types of balance mechanisms and/or compressing forces of the jambliners. The balance mechanisms are usually incorporated into the jambliner or may be positioned between the jambliner and its associated jamb. The weather-strip such as foam or durable cloth is used to seal out air and water from between the sash and jambliner

The durability of the foam and cloth weather-strip is less than desirable. Air and moisture have a tendency to pass between the jambliner and the upper and lower sashes. Further, air and moisture also have a tendency to leak between the seam between the upper and lower sashes.

### SUMMARY OF THE INVENTION

The present invention includes a free-floating weather-strip for use between two surfaces, one surface comprises a slot having an opening, retaining edges and a back wall. The weather-strip includes a longitudinal main body having a weather-strip sealing portion and a pair of leg portions that extend into the slot and engage the retaining edges to retain the weather-strip within the slot. A pair of spring arms are attached to a backside of the main body and engage the back wall of the slot. The pair of spring arms provide a spring force that causes the weather-strip sealing portion into sealing engagement with the other of the two surfaces.

### BRIEF DESCRIPTION OF THE DRAWINGS

FIG. 1 is a perspective view of the weather-strip of the present invention.

FIG. 2 is a sectional view of the weather-strip of the present invention used in association with a jambliner for use with a double-hung window.

FIG. 3 is an alternative embodiment of the weather-strip of the present invention used in association with a jambliner.

FIG. 4 is a sectional view of an alternative embodiment of the floating weather-strip of the present invention used in association with a jambliner.

FIG. 5 is a sectional view of an alternative embodiment of the weather-strip of the present invention used in association with a jambliner for use with a double-hung window.

FIG. 6 is a sectional view of an alternative embodiment of the weather-strip of the present invention used in association with a jambliner for use with a double-hung window.

FIG. 7 is a sectional view of an alternative embodiment of the weather-strip of the present invention.

FIG. 8 is a sectional view of an alternative embodiment of the weather-strip of the present invention.

FIG. 9 is a sectional view of yet another alternative embodiment of the weather-strip of the present invention used in association with the jambliner for a double-hung window.

FIG. 10 is a sectional view of still another alternative embodiment of the weather-strip of the present invention used in association with the jambliner for a double-hung window.

### DETAILED DESCRIPTION OF THE PREFERRED EMBODIMENTS

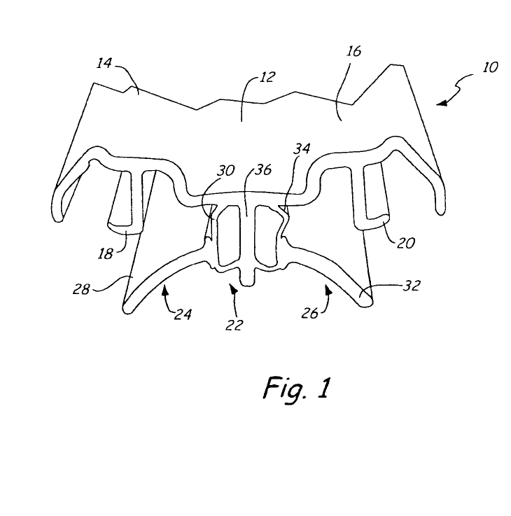

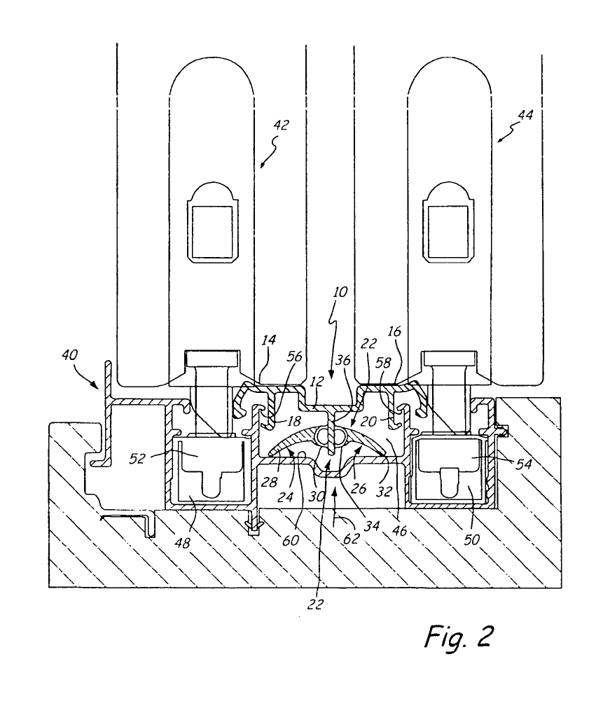

A free-floating weather-strip of the present invention is generally illustrated in FIG. 1 at 10. Referring to FIGS. 1 and 2, the free-floating weather-strip 10 is designed to be used with a jambliner 40 that guides upper and lower sashes 42, 44, respectively, of a double-hung window to prevent air and moisture from leaking between the upper and lower sashes 42, 44, and from between the jambliner 40 and the upper and lower sashes 42, 44.

The free-floating weather-strip 10 is positioned within a slot 46 of a jambliner 40. The slot 46 separates left and right channels 48, 50, that accept hardware 52, 54 attached to the sashes 42, 44, all respectively, which guide the travel of the sashes 42, 44. The weather-strip 10 includes a left weather sealing portion 14 and a right weather sealing portion 16 both of which extend beyond an entrance defined by left and right retaining edges 56 and 58 of the slot 46 and engage the upper and lower sashes 42, 44. The left and right sealing portions 14, 16 are separated by a spine 12.

An integrally formed left J-shaped leg portion 18 extends from a back surface of the left weather-sealing portion 14 and engages the left retaining edge 56. An integrally formed right J-shaped leg portion 20 extends from a back surface of the right weather-sealing portion 16 and engages the right retaining edge 58. The cooperation of the J-shaped leg portions 18, 20 and the retaining edges 56, 58, respectively, holds the weather-strip 10 to the jambliner 40.

Extending from a backside of the spine 12 is a spring mechanism 22. The spring mechanism 22 includes left and right spring arms 24 and 26. Spring arms 24 and 26 are described in U.S. Pat. Nos. 5,265,308 and 5,772,190 which are hereby incorporated by reference.

The spring arm 24 includes an arm portion 28 attached to a resilient hinge portion 30. The spring arm 26 also includes the arm portion 32 attached to a resilient hinge portion 34. The hinge portions 30 and 34 are attached to opposing sides of a common wall 36 that extend substantially perpendicularly from the backside of the spine 12. The spring mechanism 22 along with the spine 12, the left weather-sealing portion 14, the right weather sealing portion 16, and the left and right J-shaped leg portions 18, 20 are preferably integrally formed by an extrusion process.

The sashes 42, 44 engage the weather sealing portions 14, 16 and force the spine 12 and the J-shaped leg portions 18, 20 into the slot such that the J-shaped leg portions 18, 20 disengage from the retaining edges or lips 56, 58, respectively. The spring arms 24 and 26 engage a back wall 60 of the slot 46 and provide a spring force in a general direction indicated by arrow 62 that opposes the force applied to the weather-strip 10 by the sashes 42, 44. The spring force provided by the spring arms 24 and 26 forces the weather sealing portions 14 and 16 against the window sashes 42, 44, all respectively, to form a weather seal.

When the window sashes 42, 44 are disengaged from the weather sealing portions 14, 16, the spring force created by the spring arms 24 and 26 forces the J-shaped legs 18, 20 into an engagement with the retaining edges 56, 58, respectively. The engagement of the J-shaped legs 18, 20 with the edges 56, 58 retains the weather-strip 10 to the jambliner 40.

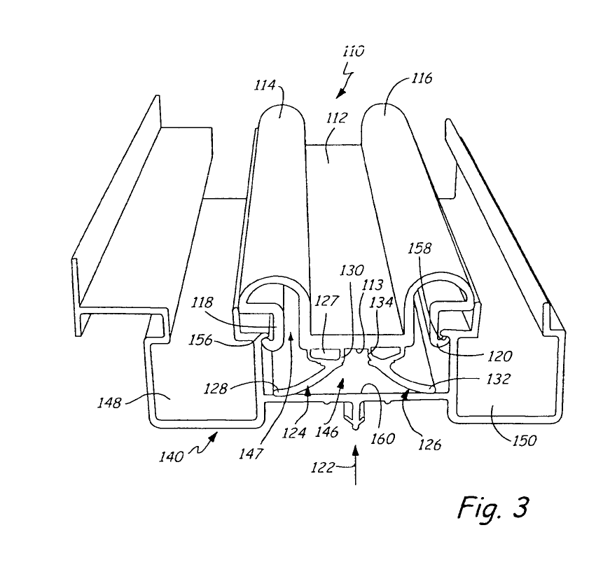

An alternative embodiment of the free-floating weather-strip of the present invention is generally indicated at 110 in FIG. 3. The free-floating weather-strip 110 is positioned within a slot 146 in a jambliner 140 that separates recesses 148, 150 that engage hardware (not shown) attached to upper and lower sashes (not shown) where the recesses 148, 150 guide the movement of the upper and lower sashes (not shown). The weather-strip 110 includes a spine 112 and integrally formed left and right weather sealing portions 114 and 116 that extend above an entrance (defined by retaining edges 156 and 158) to the slot 146 and form a weather seal with the upper and lower sashes (not shown).

Left and right J-shaped legs 118, 120 extending from the left and right weather sealing portions 114, 116 engage left and right retaining edges 156, 158, all respectively. The engagement of the left and right J-shaped legs 118, 120 with the left and right retaining edges 156, 158, respectively, retain the weather-strip 110 to the jambliner 140.

Left and right spring arms 124 and 126 are attached to a backside 113 of the spine 112 and extend rearwardly therefrom. The spring arm 124 includes an arm portion 128 and a flexible hinge 130 attached to the backside 113. Similarly, the spring arm 126 includes an arm portion 132 attached to a flexible hinge 134 which in turn is attached to the backside 113.

The spring arms 126 and 128 are similar to the spring arms 24 and 26 described previously with respect to the embodiment 10 as illustrated in FIGS. 1 and 2. It should be noted, however, that the spring arms 124 and 126 are positioned such that the concave surfaces of the arm portions 128 and 132 extend away from a back wall 160 of the slot 146 in contrast to the position of the spring arms 24 and 26 with respect to the embodiment 10 as illustrated in FIGS. 1 and 2 where the concave surface of the arm portions 28 and 32 are directed toward the back wall 60 of the slot 46.

When the sealing portions 114 and 116 are engaged with the window sashes (not shown) as previously described with reference to the embodiment 10 as illustrated in FIGS. 1 and 2, the spring arms 124 and 126 provide a counterforce in a general direction indicated by arrow 122 and opposite a force imposed upon the weather-strip 110 by the window sashes (not shown) to place the sealing portions 114, 116 in sealing engagement with the window sashes (not shown). The window sashes (not shown), when acting on the weather sealing portions 114 and 116, push the weather-strip 110 into the slot 146, and disengage the legs 118, 120 from engagement with the retaining edges 156, 158, respectively.

When the window sashes (not shown) are disengaged from the weather sealing portions 114, 116, the leg portions 118, 120 engage the retaining edges 156, 158, and retain the weather-strip 110 therein. The spine 112, the left and right weather sealing portions 114, 116, the legs 118, 120, the left and right spring arms 124, 126, are preferably extruded as an integral member.

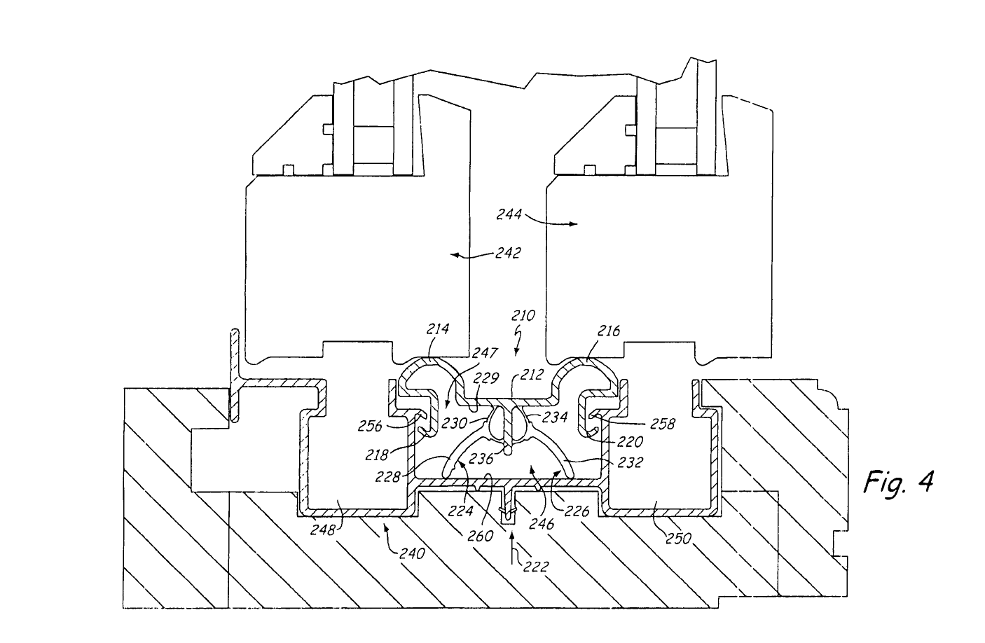

An alternative embodiment of the weather-strip of the present invention is generally indicated at 210 in FIG. 4. The weather-strip 210 is positioned within a slot 246 of a jambliner 240. The slot 246 has an entrance defined by retaining edges 256, 258. The slot 246 is positioned between recesses 248, 250 that engage hardware (not shown) for guiding the movement of upper and lower sashes 242, 244. The weather-strip 210 is retained within the slot 246 with left and right J-shaped leg portions 218, 220 that engage the edges 256, 258, respectively.

The J-shaped leg portions 218, 220 extend from left and right weather sealing portions 214, 216 that engage the upper and lower sashes 242, 244, all respectively, to form a weather seal. The left and right weather sealing portions 214, 216 are separated by a spine 212.

The spine has a common wall 236 extending substantially perpendicularly from a rear side thereof. Left and right spring arms 224, 226, respectively are attached to opposite sides of the common wall 236 and engage a back wall 260 of the slot 246. The left spring arm 224 includes an arm portion 228 and a flexible hinge portion 230 attached to the common wall 236. The right spring arm 226 includes an arm portion 232 and a flexible hinge portion 234 attached to the common wall 236. The left and right spring arms 224, 226 provide a spring force in a general direction of arrow 222 in opposition to the forces generated on the weather-strip 210 by the upper and lower window sashes 242, 244.

The forces provided by the sashes 242, 244 and the spring arms 224, 226 place the sealing portions 214, 216 in sealing engagement with the window sashes 242, 244. When the weather-strip 210 is in sealing engagement with the window sashes 242, 244, the J-shaped legs 218, 220 are forced into the slot 246 and disengage from the edges 256, 258. When the sashes 242, 244 are disengaged from the weather-strip 210, the J-shaped legs 218, 220 engage the edges 256, 258, respectively, to retain the weather-strip 210 to the jambliner 240.

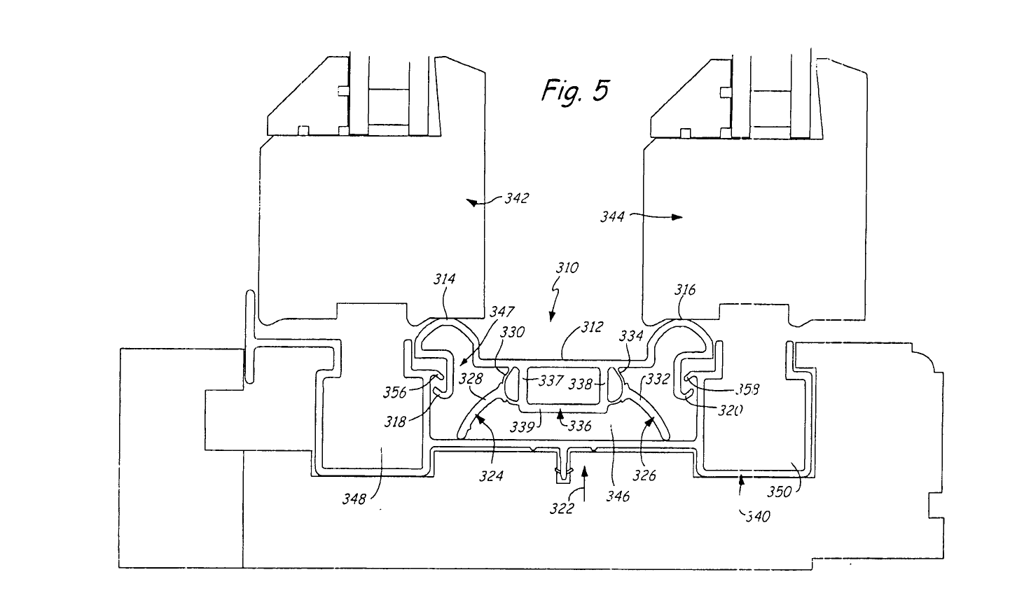

Another embodiment of the free-floating weather-strip of the present invention is generally indicated at 310 in FIG. 5. The free-floating weather-strip 310 is positioned within a slot 346 in a jambliner 340 where the slot 346 separates channels 348, 350 for guiding the movement of the upper and lower sashes 342, 344, respectively. The weather-strip 310 includes J-shaped leg portions 318, 320 extending into the slot 346 that engage retaining edges 356, 358, respectively, which define an entrance to the slot 346 and retain the weather-strip 310 therein.

Extending from the J-shaped leg portions 318, 320 are left and right weather sealing portions 314, 316 that are separated by a spine 312. The weather sealing portions 314, 316 extend above the slot 346 and engage the upper and lower sashes 342, 344 and form a weather seal that prevents weather and the elements from leaking between the upper and lower sashes 342, 344 and from between the jambliner 340 and the upper and lower sashes 342, 344.

The upper and lower sashes 342, 344 exert a force on the weather sealing portions 314, 316, respectively. Spring arms 324, 326 attached to a reinforced structure 336 extending from the spine 312 exert a counterforce which creates the weather seal between the upper and lower sashes 342, 344 and the weather sealing portions 314, 316 that prevents leakage from between the sashes 342, 344 and between the sashes 342, 344 and the jambliner 340. The spring arms 324, 326 are substantially similar to the spring arms previously described and have leg portions 328, 332 connected to hinge portions 330, 334 which in turn are connected to the side walls 337, 338, all respectively. The reinforcing structure 336 is preferably rectangular in cross-section where the spring arms 324, 326 are attached to the side walls 337, 338 that extend substantially perpendicularly from a back surface of the spine 312.

When pressure is exerted upon the weather strip 310 by the upper and lower sashes 342, 344, the spring arms 324, 326 exert a counterforce substantially in the direction of arrow 322 and create a sealing engagement between the window sashes 342, 344 and weather sealing portions 314, 316. When the window sashes 342, 344 exert a force upon the sealing portions 314, 316, the J-shaped leg portions 318, 320 are disengaged from the retaining edges 356, 358 and extend into the slot 346. However, when the sashes 342, 344 are disengaged from the jambliner 340 and the weather-strip 310, the J-shaped leg portions 318, 320 engage the edges 356, 358 and retain the weather-strip 310 in the slot 346.

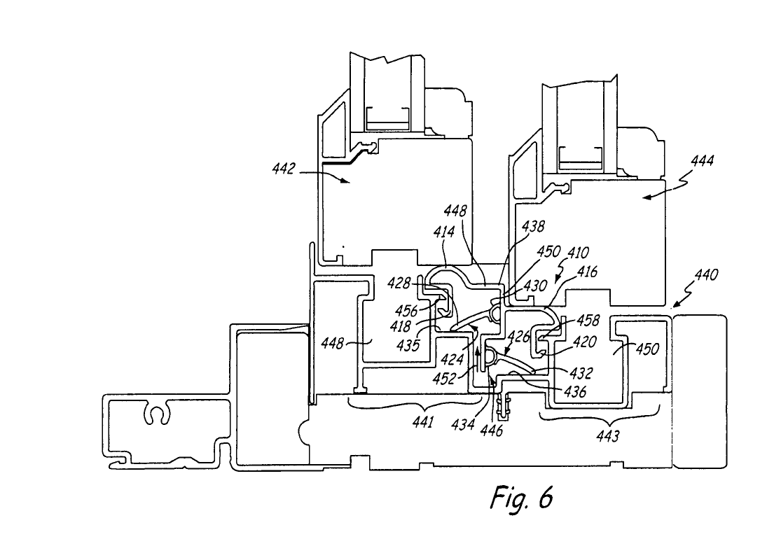

Another alternative embodiment of the free-floating weather-strip of the present invention is indicated at 410 in FIG. 6. The weather-strip is secured within a jambliner 440 that is used in association with window sashes 442, 444 that are in an offset configuration from each other. By offset configuration is meant that the window sashes 442, 444 contact the jambliner 440 in vertical planes that are offset from each other.

The jambliner 440 is constructed to have first and second sections 441, 443 which are offset. The sections 441, 443 each have recesses 448, 450, respectively, for engaging hardware (not shown) that guides the movement of the sashes 442, 444. The free-floating weather-strip 410 is positioned within a slot 446 separating the recesses 448, 450 and is retained within the slot 446 by retaining edges 456, 458 which engage left and right J-shaped legs 418, 420, respectively. One skilled in the art will recognize that the edge portions 456, 458 and the J-shaped legs 418, 420 are vertically offset from each other to accommodate the offset sashes 442, 444. The edges portions 456, 458, although offset from each other, define an entrance to the slot 446.

The weather-strip 410 includes a midsection 438 integrally extruded with weather sealing portions 414, 416. The portions 414, 416 extend in opposite directions from the midsection 438 and are offset from each other the same vertical distance that the sashes 442, 444 are offset from each other. The midsection 438 has a segment 448 adjacent to the weather sealing portion 414 that is substantially parallel to a face of the window sash 442 that engages the sealing portion 414. The midsection 438 has a common wall 450 which is substantially perpendicular to the common wall 448. The weather-sealing portion 416 extends from the common wall 450 perpendicularly and substantially parallel to the face of the sash 444 that engages the weather-sealing portion 416.

To provide a force in a general direction of arrow 452 that is opposite the force generated by the sashes 442, 444 upon the weather sealing portions 414, 416, respectively, spring arms 424, 426 are attached to opposing sides of the common wall 450. The spring arms 424, 426 are offset substantially the same distance that the sashes 442, 444 are offset from each other, and each spring arm 424, 426 includes flexible hinge 430, 434 and an arm portion 428, 432, all respectively, where the arm portions 428, 432 engage bottom surfaces 435, 436 of the slot 446.

As a force is applied by the sashes 442, 444 to the sealing portions 414, 416, respectively, an opposite force in the direction of arrow 452 is forced upon the sashes 442, 444 by the spring arms 424, 426 and thereby creates a sealing contact between the sashes 442, 446 and the sealing portions 414, 416. When the sashes 442, 444 are disengaged from the sealing portions 414, 416, the J-shaped legs 418, 420 engage the edges 456, 458 which define an entrance to the slot 446 and retain the weather-strip 410 to the jambliner 440.

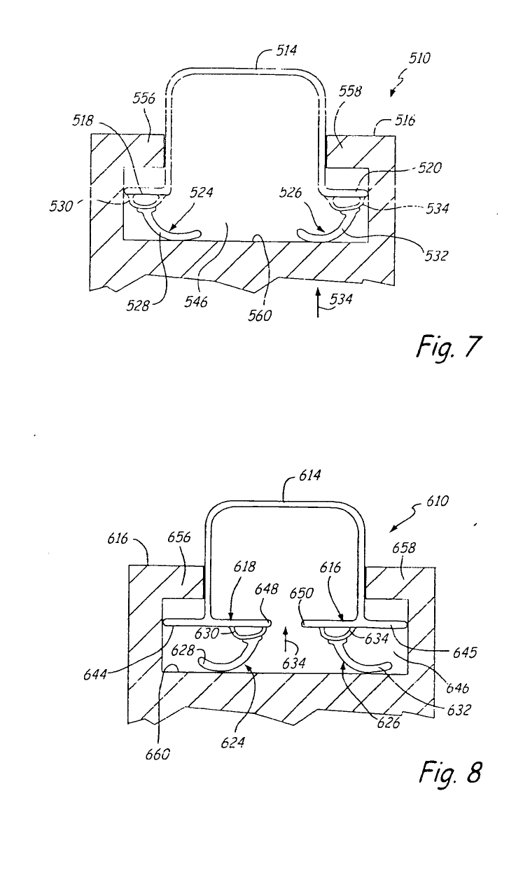

Additional alternative embodiments of the free-floating weather-strip are illustrated generally at 510 and 610 in FIGS. 7 and 8, respectively. The weather-strips 510 and 610 are free-floating weather-strips that are useful for providing a weather seal for casement-type windows or doors or windows or doors that slide. A casement window or door pivots in contrast to a double-hung window which slides along a jambliner. In addition, the weather-strips 510 and 610 are also useful in situations wherein the door or window is slid, such as along a track and wherein the door or window abuts against the free-floating weather-strip 510 or 610 to form a weather seal.

With reference to FIG. 7, the weather-strip 510 includes a weather sealing portion 514 that extends beyond a face surface 516 of a door or window or a surface against which the door or window faces when in a closed position. The free-floating weather-strip includes leg portions 518 and 520 that extend into a recess 546. The opening of the recess 546 is defined by retaining edges 556 and 558 which engage leg portions 518 and 520 to retain the weather-strip 510. Spring arms 524 and 526 are attached to a rear side of the leg portions 518 and 520, respectively. The spring arms 524 and 526 include hinge portions 530 and 534 and arm portions 528 and 532. The spring arms abut against a rear wall 560 of the recess 546. When the weather-strip 510 is in a sealing engagement with another surface, the spring arms 524 and 526 provide a force in the general direction of arrow 534. Spring arms 524 and 526 are of the same general construction as the spring arms previously described with respect to FIGS. 1-4.

Referring to FIG. 8, the weather-strip 610 also includes a weather sealing portion 614 which extends beyond a front face 616 of the door or window or the surface against which a door or window faces or abuts. The weather-strip 610 includes leg portions 618 and 616 which have shoulder engaging segments 644 and 645 extending in opposite directions to engage shoulders 656 and 658, respectively. In addition, the leg portions 618 and 616 have inwardly extending segments 648 and 650 that extend towards each other. On a back surface of the segments 648 and 650 are attached spring arms 624 and 626 which engage a rearward wall 660 of the recess 646. The spring arms 624, 626 have hinge portions 630, 634 and arm portions 628 and 632 and are of the same general construction as the spring arms of FIGS. 1-4.

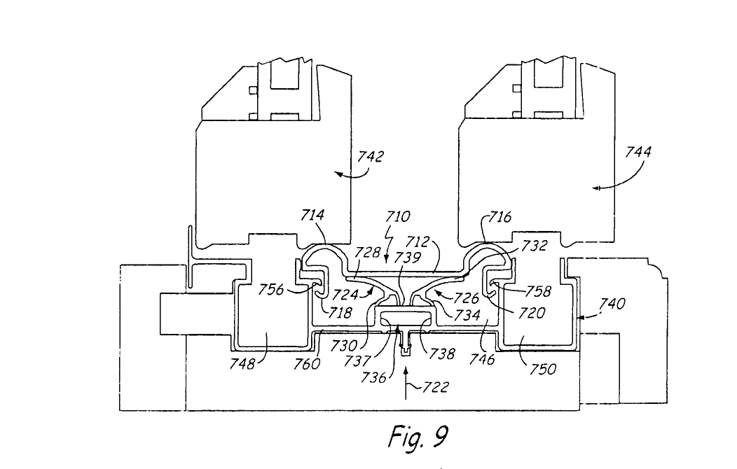

Another embodiment of the free-floating weather-strip of the present invention is generally indicated at 710 in FIG. 9. The embodiment of FIG. 9 is similar to the embodiment 310 in FIG. 5 but with spring arms 724, 726 being secured to the jambliner 740 while pushing against the weather-strip 710. Weather-strip 710 is positioned within a slot 746 of the jambliner 740. The slot 746 separates channels 748, 750 for guiding the movement of upper and lower window sashes 742, 744 respectively. The weather-strip 710 includes J-shaped leg portions 718, 720 that extend into the slot 746. The J-shaped leg portions engage retaining edges 756, 758, respectively, which define an entrance to the slot 746 and retain the weather-strip 710 therein.

Extending from the J-shaped leg portions 718, 720, are left and right weather sealing portions 714, 716 that are separated by a spine 712. The weather sealing portions 714, 716 extend above the slot 746 and engage the upper and lower sashes 742, 744 and form a weather seal that prevents weather and the elements from leaking between the upper and lower sashes 742, 744 and from between the jambliner 740 and the upper and lower sashes 742 and 744.

The upper and lower sashes 742, 744 exert a force on the weather sealing portions 714, 716, respectively. The spring arms 724, 726 are attached to a reinforced structure 736 that extends from a backwall 760. The spring arms 724 and 726 exert a counterforce against the weather-strip 710 such that sealing portions 714, 716 prevent leakage from between the sashes 742, 744 and between the sashes 742, 744 and the jambliner 740. The spring arms 724, 726 are substantially similar to the spring arms previously described, having leg portions 728, 732 connected to hinge portions 730, 734 which are turn are connected to a common wall 739. The common wall 739 is spaced from the backwall 760 and places the spring arms 724, 726 at a position for optimum engagement of the weather-strip 710. However, depending on the configuration of the jambliner 740, the common wall 739 may be positioned closer or farther from the backwall 760 and in some configurations may even be eliminated such as the spring arms 724 and 726 being mounted directly on the backwall 760. In the embodiment illustrated, the structure 736 is preferably rectangular in cross-section and the common wall 739 being supported by adjacent sidewalls 737 and 738 projecting from the backwall 760.

When pressure is exerted upon the weather-strip 710 by the upper and lower sashes 742, 744, the spring arms 724, 726 exert a counterforce substantially in the direction of arrow 722, to create a sealing engagement between the window sashes 742, 744 and the weather-sealing portion 714, 716. When the window sashes 742, 744 exert a force upon the sealing portion 714, 716, the J-shaped leg portion 718, 720 are disengaged from the retaining edges 756, 758 and extend into the slot 746. However, when the sashes 742, 744 are disengaged from the jambliner 740 and the weather-strip 710, the J-shaped leg portion 718, 720 engage the edges 756, 758 retaining the weather-strip 710 in the slot 746.

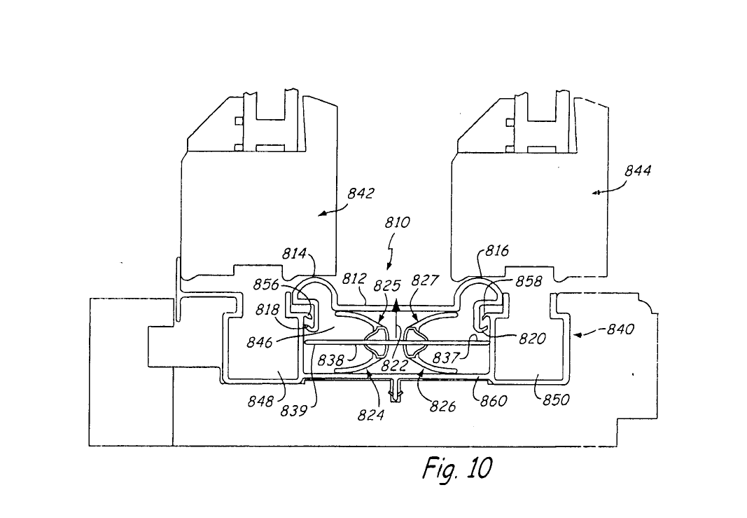

A further alternative embodiment of the free-floating weather-strip is indicated at 810 in FIG. 10. Similarly, the free-floating weather-strip 810 is positioned within a slot 846 of a jambliner 840. The slot 846 separates channels 848, 850 for guiding the movement of upper and lower window sashes 842, 844, respectively. The weather-strip 810 includes J-shaped leg portions 818, 820 that extend into the slot 846 and engage retaining edges 856, 858, respectively which in turn define an entrance into the slot 846 and retain the weather-strip 810 therein.

Extending from the J-shaped leg portions 818, 820 are left and right sealing portions 814, 816 that are separated by a spine 812. The weather sealing portions 814, 816 extend above the slot 846 and engage the upper and lower sashes 842, 844 to form a weather seal that prevents weather and the elements from leaking between the upper and lower sashes 842, 844 and from between the jambliner 840 and the upper and lower sashes 842, 844.

The upper and lower sashes 842, 844 exert a force on the weather sealing portions 814, 816, respectively. Free-floating common wall 839 is disposed within the slot 846. Forwardly positioned spring arms 825, 827 are mounted on a forward surface 837 of the wall 839. Similarly, rearwardly positioned spring arms 824 and 826 are mounted on a rearward surface 838 of the common wall 839. Spring arms 824, 825, 826 and 827 are similar to the spring arms described previously in that they contain a hinge portion and an arm portion and provide a spring force. The forwardly positioned spring arms 825, 827 provide a spring force to the free-floating weather-strip in a direction of arrow 822. Similarly, the rearwardly positioned spring arms 824, 826 also provide a spring force in a general direction of 822. The spring 824, 826 engage a backwall 860 of the jambliner 840 while the spring arms 825 and 827 engage spine 812 of the free-floating weather-strip.

When pressure is exerted upon the weather-strip 810 by the upper and lower sashes 842, 844, the spring arms 824, 825, 826, 827 exert a counterforce to create a sealing engagement between the window sashes 842, 844 and the weather sealing portions 814, 816. When the window sashes 842, 844 exert a force upon the sealing portions 814, 816 that overcome the spring forces provided by the spring arms 824, 825, 826 and 827, the J-shaped leg portions 818, 820 are disengaged from the retaining edges 856, 858 and extend into the slot 846. However, when the sashes 842, 844 are disengaged from the jambliner 840 and the weather-strip 810, the J-shaped leg portions 814, 820 engage the edges 856, 858 and retain the weather-strip 810 in the slot 846.

Although the present invention has been described with reference to preferred embodiments, workers skilled in the art will recognize that changes may be made in form and detail without departing from the spirit and scope of the invention.

1. A free-floating weather-strip for use between two surfaces, one of the surfaces having a slot with an opening, retaining edges and a backwall, the free-floating weather-strip comprising:
a longitudinal main body having a weather-strip sealing portion and at least two leg portions for extending into the slot and for engaging the retaining edges to retain the weather-strip; and
a pair of spring arms positioned within the slot providing a spring force between the backwall and the longitudinal main body so that the weather-strip sealing portion comes into sealing engagement with the other of the two surfaces.

2. The weather-strip of claim 1 wherein each spring arm comprises:
a hinge portion attached to the backside of the longitudinal main body; and
an arm portion with a proximal end attached to the hinge portion and a distal end for engaging the backwall of the slot.

3. The free-floating weather-strip of claim 1 wherein the longitudinal main body has a back surface wherein the spring arms are attached to the back surface.

4. The free-floating weather-strip of claim 1 wherein the longitudinal main body has a back surface and a common wall projecting from the back surface and the spring arms are attached to the common wall on opposing surfaces.

5. The free-floating weather-strip of claim 1 wherein the pair of spring arms are attached to a backside of the main body with the spring arms extending toward the backwall of the slot to engage the backwall of the slot.

6. The free-floating weather-strip of claim 1 wherein the spring arms are attached to the backwall and extend toward the main body to engage the main body.

7. The free-floating weather-strip of claim 1 further comprising a free-floating wall within the slot, the spring arms being attached to the free-floating wall with the spring arms engaging either the longitudinal main body or the backwall of the slot.

8. The free-floating weather-strip of claim 7 and further comprising an additional pair of spring arms attached to the free-floating wall such that two spring arms are attached on one side of the free-floating wall and two spring arms are attached to the other side of the free-floating wall.

9. A jamb liner mountable in a window jamb wherein the jamb liner guides a sliding window and forms a weather resistant seal with the sliding window, the jamb liner comprising:
at least one recess for engaging and guiding a sliding window;
a slot proximate the recess wherein the slot comprises an opening, retaining edges and a back wall; and
a free-floating weather strip comprising:
a longitudinal main body having a sealing portion and at least two leg portions that extend into the slot and engage the retaining edges to retain the weather-strip; and
a pair of spring arms attached to a backside of the longitudinal main body and extending toward the backwall of the slot which provides a spring force so that the sealing portion comes into sealing engagement with the sliding window.

10. The jamb liner of claim 9 wherein each spring arm comprises:
a hinge portion attached to the backside of the longitudinal main body; and
an arm portion with a proximal end attached to the hinge portion and a distal end for engaging the backwall of the slot.

11. The jamb liner of claim 9 wherein the longitudinal main body has a back surface wherein the spring arms are attached to the back surface.

12. The jamb liner of claim 9 wherein the longitudinal main body has a back surface and a common wall projecting generally perpendicularly from the back surface and the spring arms are attached to the common wall on opposing surfaces.

13. The jambliner of claim 9 wherein the pair of spring arms are attached to a backside of the main body with the spring arms extending toward the backwall of the slot to engage the backwall of the slot.

14. The jambliner of claim 9 wherein the spring arms are attached to the backwall and extend toward the main body to engage the main body.

15. The jambliner of claim 9 further comprising a free-floating wall within the slot, the spring arms being attached to the free-floating wall with the spring arms engaging either the longitudinal main body or the backwall of the slot.

16. The jambliner of claim 9 and further comprising an additional pair of spring arms attached to the free-floating wall such that two spring arms are attached on one side of the free-floating wall and two spring arms are attached to the other side of the free-floating wall.
